(19) United States
(12) Patent Application Publication
(10) Pub. No.: US 2008/0310757 A1
(43) Pub. Date: Dec. 18, 2008

(54) System and related methods for automatically aligning 2D images of a scene to a 3D model of the scene

(76) Inventors: George Wolberg, Woodmere, NY (US); Lingyun Liu, Sunnyvale, CA (US); Ioannis Stamos, Brooklyn, NY (US); Gene Yu, Brooklyn, NY (US); Siavash Zokai, New York, NY (US)

Correspondence Address: SHELDON MAK ROSE & ANDERSON PC, 100 Corson Street, Third Floor, PASADENA, CA, 91103-3842, US

(21) Appl. No.: 12/157,595

(22) Filed: Jun. 11, 2008

Related U.S. Application Data
(60) Provisional application No. 60/934,692, filed on Jun. 15, 2007.

(51) Int. Cl. G06K 9/36

(52) U.S. Cl. 382/285

(57) ABSTRACT

A system and related method for automatically aligning a plurality of 2D images of a scene to a first 3D model of the scene. The method includes providing a plurality of 2D images of the scene, generating a second 3D model of the scene based on the plurality of 2D images, generating a transformation between the second 3D model and the first 3D model based on a comparison of at least one of the plurality of 2D images to the first 3D model, and using the transformation to automatically align the plurality of 2D images to the first 3D model.

### CROSS-REFERENCE TO RELATED APPLICATION

This application claims the benefit of U.S. Provisional Patent Application Ser. No. 60/934,692, filed Jun. 15, 2007, titled “System and Related Methods for Automatically Aligning 2D Images of a Scene to a 3D model of the Scene.”

### STATEMENT REGARDING FEDERALLY SPONSORED RESEARCH OR DEVELOPMENT

This invention was made in part with U.S. government support under contract numbers NSF CAREER IIS-0237878, NSF MRI/RUI EIA-0215962, ONR N000140310511, and NIST ATP 70NANB3H3056. Accordingly, the U.S. Government has a paid-up license in this invention and the right in limited circumstances to require the patent owner to license others on reasonable terms as provided for by the terms of contract numbers NSF CAREER IIS-0237878, NSF MRI/RUI EIA-0215962, ONR N000140310511, and NIST ATP 70NANB3H3056.

### FIELD OF THE INVENTION

The present invention generally relates to photorealistic modeling of large-scale scenes, such as urban structures. More specifically, the present invention relates to a system and related methods for automatically aligning 2D images of a scene to a 3D model of the scene.

### BACKGROUND

The photorealistic modeling of large-scale scenes, such as urban structures, requires a combination of range sensing technology with traditional digital photography. A systematic way for registering 3D range scans and 2D images is thus essential.

Several papers, provide frameworks for automated texture mapping onto 3D range scans (see Katsushi Ikeuchi, Atsushi Nakazawa, Kazuhide Hasegawa, & Takeshi Ohishi, The Great Buddha Project: Modeling Cultural Heritage for VR Systems through Observation, 2003 IEEE/ACM International Symposium on Mixed and Augmented Reality, IEEE Computer Society at 7-18, L. Liu & I. Stamos, Automatic 3D to 2D registration for the photorealistic rendering of urban scenes, IEEE Computer Society Conference on Computer Vision and Pattern Recognition, 2 IEEE CVPR, at 137-143 (2005), I. Stamos & P. K. Allen, Automatic registration of 3-D with 2-D imagery in urban environments, Eighth IEEE International Conference on Computer Vision, 2 ICCV, at 731-736, (2001), and W. Zhao, D. Nister, & S. Hsu, Alignment of continuous video onto 3D point clouds, IEEE Trans. Pattern Anal. & Mach. Intell., 27, at 1305-1318 (2005) all of which are incorporated by reference herein). These methods are based on extracting features (e.g., points, lines, edges, rectangles or rectangular parallelepipeds) and matching them between the 2D images and the 3D range scans.

Despite the advantages of feature-based texture mapping solutions, most systems that attempt to recreate photorealistic models do so by requiring the manual selection of features among the 2D images and the 3D range scans, or by rigidly attaching a camera onto the range scanner and thereby fixing the relative position and orientation of the two sensors with respect to each other (see C. Früh & A. Zakhor, Constructing 3D city models by merging aerial and ground views, IEEE CGA, 23(6) at 52-11 (2003); 1 K. Pulli, H. Abi-Rached, T. Duchamp, L. G. Shapiro, & W. Stuetzle, Acquisition and visualization of colored 3-D objects, ICPR, Australia, (1998), V. Sequeira & J. Concalves, 3D reality modeling: Photorealistic 3D models of real world scenes, 3DPVT, pages 776-783, 2002, and H. Zhao & R. Shibasaki, Reconstructing a textured CAD model of an urban environment using vehicle-borne laser range scanners and line cameras, MVA, 14(1) at 35-41, (2003) all of which are incorporated by reference herein). The fixed-relative position approach provides a solution that has the following major limitations:

1. The acquisition of the images and range scans occur at the same point in time and from the same location in space. This leads to a lack of 2D sensing flexibility since the limitations of 3D range sensor positioning, such as standoff distance and maximum distance, will cause constraints on the placement of the camera. Also, the images may need to be captured at different times, particularly if there were poor lighting conditions at the time that the range scans were acquired.

2. The static arrangement of 3D and 2D sensors prevents the camera from being dynamically adjusted to the requirements of each particular scene. As a result, the focal length and relative position must remain fixed.

3. The fixed-relative position approach cannot handle the case of mapping historical photographs on the models or of mapping images captured at different instances in time.

In summary, fixing the relative position between the 3D range and 2D image sensors sacrifices the flexibility of 2D image capture. Alternatively, methods that require manual interaction for the selection of matching features among the 3D scans and the 2D images are error-prone, slow, and not scalable to large datasets.

There are many approaches for the solution of the pose estimation problem from both point correspondences (see D. Oberkampf, D. DeMenthon, and L. Davis. Iterative pose estimation using coplanar feature points. CVGIP, 63(3), May 1996, and L. Quan and Z. Lan. Linear N-point camera pose determination. PAMI, 21(7), July 1999, which are incorporated by reference herein) and line correspondences (see S. Christy and R. Horaud. Iterative pose computation from line correspondences. CVIU, 73(1):137-144, January 1999, and R. Horaud, F. Dornaika, B. Lamiroy, and S. Christy. Object pose: The link between weak perspective, paraperspective, and full perspective. IJCV, 22(2), 1997, which are incorporated by reference herein), when a set of matched 3D and 2D points or lines are known, respectively. In the early work of M. A. Fischler and R. C. Bolles. Random sample consensus: A paradigm for model fitting with applications to image analysis and automated cartography. Graphics and Image Processing, 24(6):381-395, June 1981, which is incorporated by reference herein, the probabilistic Random Sample Consensus (“RANSAC”) method was introduced for automatically computing matching 3D and 2D points. Solutions in automated matching of 3D with 2D features in the context of object recognition and localization include those discussed in T. Cass. Polynomial-time geometric matching for object recognition. IJCV, 21(1-2):37-61, 1997, G. Hausler and D. Ritter. Feature-based object recognition and localization in 3D-space, using a single video image. CVIU, 73(1): 64-81, 1999, D. Huttenlocher and S. Ullman. Recognizing solid objects by alignment with an image. IJCV, 5(7): 195-212, 1990, D. W. Jacobs. Matching 3-D models to 2-D images. IJCV, 21(1-2): 123-153, 1997, F. Jurie. Solution of the simultaneous pose and correspondence problem using gaussian error model. CVIU, 73(3): 357-373, March 1999, and W. Wells. Statistical approaches to feature-based object recognition. IJCV, 21(1-2): 63-98, 1997, which are incorporated by reference herein. Very few methods, though, attack the problem of automated alignment of images with dense point clouds derived from range scanners. This problem is of major importance for automated photorealistic reconstruction of large-scale scenes from range and image data. In I. Stamos and P. K. Allen. Automatic registration of 3-D with 2-D imagery in urban environments. supra., and L. Liu and I. Stamos. supra., two methods that exploit orthogonality constraints (rectangular features and vanishing points) in man-made scenes are presented. The methods can provide excellent results, but will fail in the absence of a sufficient number of linear features. In K. Ikeuchi. supra., on the other hand, presents an automated 2D-to-3D registration method that relies on the reflectance range image. However, the algorithm requires an initial estimate of the image-to-range alignment in order to converge. Finally, A. Troccoli and P. K. Allen. A shadow based method for image to model registration. In 2nd IEEE Workshop on Video and Image Registration, July 2004, which is incorporated by reference herein, presents a method that works under specific outdoor lighting situations.

In W. Zhao, D. Nister, and S. Hsu. supra., continuous video is aligned onto a 3D point cloud obtained from a 3D sensor. First, an SFM/stereo algorithm produces a 3D point cloud from the video sequence. This point cloud is then registered to the 3D point cloud acquired from the range scanner by applying the ICP algorithm (see P. Besl and N. McKay. A method for registration of 3D shapes. IEEE Trans. Patt. Anal. and Machine Intell., 14(2), 1992, which is incorporated by reference herein). One limitation of this approach has to do with the shortcomings of the ICP algorithm. In particular, the 3D point clouds must be manually brought close to each to yield a good initial estimate that is required for the ICP algorithm to work. The ICP may fail in scenes with few discontinuities, such as those replete with planar or cylindrical structures. Also, in order for the ICP algorithm to work, a very dense model from the video sequence must be generated. This means that the method of W. Zhao, D. Nister, and S. Hsu. supra. is restricted to video sequences, which limits the resolution of the 2D imagery. Finally, that method does not automatically compute the difference in scale between the range model and the recovered SFM/stereo model.

The invention disclosed herein remedies these disadvantages.

### SUMMARY

This document presents a system that integrates multiview geometry and automated 3D registration techniques for texture mapping 2D images onto 3D range data. The 3D range scans and the 2D photographs are respectively used to generate a pair of 3D models of the scene. The first model consists of a dense 3D point cloud, produced by using a 3D-to-3D registration method that matches 3D lines in the range images. The input is not restricted to laser range scans. Instead, any existing 3D model as produced by conventional 3D computer modeling software tools such as Maya®, 3DS Max, and SketchUp, may be used. The second model consists of a sparse 3D point cloud, produced by applying a multiview geometry (structure-from-motion aka “SFM”) algorithm directly on a sequence of 2D photographs. This document introduces a novel algorithm for automatically recovering the rotation, scale, and translation that best aligns the dense and sparse models. This alignment is necessary to enable the photographs to be optimally texture mapped onto the dense model. The contribution of this work is that it merges the benefits of multiview geometry with automated registration of 3D range scans to produce photorealistic models with minimal human interaction. Also, this work exploits all possible relationships between 3D range scans and 2D images by performing 3D-to-3D range registration, 2D-to-3D image-to-range registration, and structure from motion.

An exemplary method according to the invention is a method for automatically aligning a plurality of 2D images of a scene to a first 3D model of the scene. In this document, the word “plurality” means two or more. The method includes providing a plurality of 2D images of the scene, generating a second 3D model of the scene based on the plurality of 2D images, generating a transformation between the second 3D model and the first 3D model based on a comparison of at least one of the plurality of 2D images to the first 3D model, and using the transformation to automatically align the plurality of 2D images to the first 3D model.

In other, more detailed features of the invention, the step of generating a second 3D model based on the plurality of 2D images includes generating a sparse 3D point cloud from the plurality of 2D images using a multiview geometry algorithm. Also, the multiview geometry algorithm can be a structure-from-motion algorithm.

In other, more detailed features of the invention, the scene includes an object that includes a plurality of features. Each of the plurality of features has one of a plurality of 3D positions. The plurality of 2D images is created using a 2D sensor that was at one of a plurality of sensor positions relative to the image when each of the plurality of 2D images was created. The multiview geometry algorithm is used to determine at least one of the plurality of sensor positions and at least one of the plurality of 3D positions.

In other, more detailed features of the invention, each of the plurality of 2D images was collected from one of a plurality of viewpoints, and no advance knowledge of the plurality of viewpoints is required before performing the above method if at least one of the plurality of 2D images overlaps the 3D model. Also, the step of generating the transformation between the second 3D model and the first 3D model can include generating a rotation, a scale factor, and a translation.

Another exemplary method according to the invention is a method for texture mapping a plurality of 2D images of a scene to a 3D model of the scene. The method includes providing a plurality of 3D range scans of the scene, generating a first 3D model of the scene based on the plurality of 3D range scans, providing a plurality of 2D images of the scene, generating a second 3D model of the scene based on the plurality of 2D images, registering at least one of the plurality of 2D images with the first 3D model, generating a transformation between the second 3D model and the first 3D model as a result of registering the at least one of the plurality of 2D images with the first 3D model, and using the transformation to automatically align the plurality of 2D images to the first 3D model.

In other, more detailed features of the invention, the plurality of 3D range scans include lines, and the step of generating the first 3D model based on the plurality of 3D range scans includes generating a dense 3D point cloud using a 3D-to-3D registration method. The 3D-to-3D registration method includes matching the lines in the plurality of 3D range scans, and bringing the plurality of 3D range scans into a common reference frame.

In other, more detailed features of the invention, the plurality of 3D range scans was collected from a first plurality of viewpoints, the plurality of 2D images was collected from a second plurality of viewpoints, and not all of the second plurality of viewpoints coincide with the first plurality of viewpoints.

An exemplary embodiment of the invention is a system that includes a computer. The computer is configured to receive as input a plurality of 2D images of a scene and a plurality of 3D range scans of the scene, and includes a computer-readable medium having a computer program that is configured to generate the first 3D model of the scene based on the plurality of 3D range scans, generate a second 3D model of the scene based on the plurality of 2D images, register at least one of the plurality of 2D images with the first 3D model, generate a transformation between the second 3D model and the first 3D model as a result of the registering of the at least one of the plurality of 2D images with the first 3D model, and use the transformation to automatically align the plurality of 2D images to the first 3D model.

In other, more detailed features of the invention, the system further includes a 3D sensor that is configured to be coupled to the computer and to generate the plurality of 3D range scans of the scene. The 3D sensor can be a laser scanner, a light detection and ranging (“LIDAR”) device, a laser detection and ranging (“LADAR”) device, a structured-light system, a scanning system based on the use of structured light that acquires 3D information by projecting a pattern of visible or laser light, or any other active sensor. Also, the system can further include a 2D sensor that is configured to be coupled to the computer and to generate the plurality of 2D images of the scene. The 2D sensor can be a camera or a camcorder, and the plurality of 2D images can be photographs or video frames.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF DRAWINGS

The patent or application file contains at least one drawing executed in color. Copies of this patent or patent application publication with color drawings will be provided by the Office upon request and payment of the necessary fee.

FIG. 1A illustrates 22 registered range scans of Shepard Hall (The City College of New York aka “CCNY”) that constitute a dense 3D point cloud model M_{range}. The color of each 3D point corresponds to the intensity of the returned laser beam, and no texture mapping has been applied yet. The five white dots correspond to the locations of the 2D images that are independently registered with the model M_{range} via a 2D-to-3D image-to-range registration algorithm.

FIG. 1B illustrates the 3D range model M_{range} overlaid with the 3D model M_{sfm} produced by SFM after the alignment method. The points of M_{sfm} are shown in red, and the sequence of 2D images that produced M_{sfm} are shown as red dots in the figure. Their positions have been accurately recovered with respect to both models M_{range} and M_{sfm}.

FIG. 2 is a block diagram that illustrates a system according to an embodiment of the present invention.

FIG. 3A1 illustrates the points of model M_{sfm} projected onto one 2D image Iₙ. The projected points are shown in green.

FIG. 3A2 illustrates an expanded view of a portion (see the yellow rectangle) of FIG. 3A1.

FIG. 3B1 illustrates the points of model M_{range} projected onto the same 2D image Iₙ (projected points shown in green) after the automatic 2D-to-3D registration. Note that the density of 3D range points is much higher than the density of the SFM points (see FIG. 3A1), due to the different nature of the two reconstruction processes. Finding corresponding points between M_{range} and M_{sfm} is possible on the 2D image space of Iₙ. This yields the transformation between the two models.

FIG. 3B2 illustrates an expanded view of a portion (see the yellow rectangle) of FIG. 3B1.

FIG. 4 is a flowchart of a method for texture mapping a plurality of 2D images of a scene to a 3D model of the scene according to the present invention.

FIG. 5A illustrates a range model of Shepard Hall (CCNY) with 22 automatically texture mapped high resolution images.

FIG. 5B illustrates a range model of an interior scene (Great Hall at CCNY) with seven automatically texture mapped images. The locations of the recovered camera positions are shown. Notice the accuracy of the photorealistic result.

### DETAILED DESCRIPTION

The texture mapping solution described herein and in L. Liu, I. Stamos, G. Yu, G. Wolberg, S. Zokai. Multiview Geometry for Texture Mapping 2D Images Onto 3D Range Data, IEEE International Conference of Computer Vision and Pattern Recognition, New York, N.Y., Jun. 17-22 2006, which is incorporated by reference herein, merges the benefits of multiview geometry with automated 3D-to-3D range registration and 2D-to-3D image-to-range registration to produce photorealistic models with minimal human interaction. The 3D range scans and the 2D photographs are respectively used to generate a pair of 3D models of the scene. The first model consists of a dense 3D point cloud, produced using a 3D-to-3D registration method that matches 3D lines in the range images to bring them into a common reference frame. The input is not restricted to laser range scans. Instead, any existing 3D model as produced by conventional tools such as Maya®, 3DS Max®, and SketchUp, may be used. The second model consists of a sparse 3D point cloud, produced by applying a multiview geometry (structure-from-motion) algorithm, which is also known as SLAM, or Simultaneous Localization and Mapping, directly on a sequence of 2D photographs to simultaneously recover the camera motion and the 3D positions of image features.

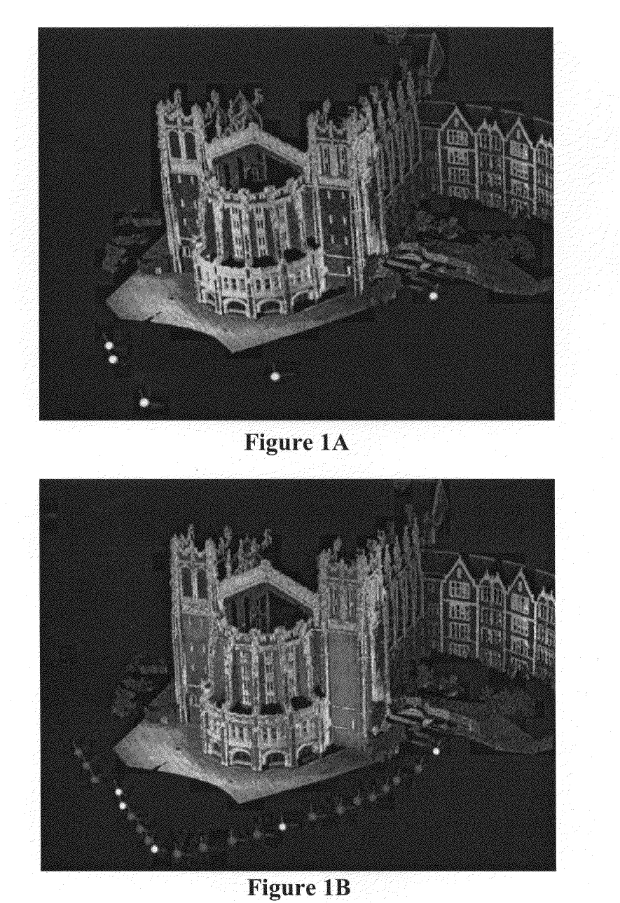

This document introduces a novel algorithm for automatically recovering the similarity transformation (rotation/scale/translation) that best aligns the sparse and dense models. This alignment is necessary to enable the photographs to be texture mapped onto the dense model in an optimal manner. No a priori knowledge about the camera poses relative to the 3D sensor's coordinate system is needed, other than the fact that one image frame should overlap the 3D structure (see Section 2). Given one sparse point cloud derived from the photographs and one dense point cloud produced by the range scanner, a similarity transformation between the two point clouds is computed in an automatic and efficient way (see FIG. 1). The framework of the system according to embodiments of the present invention is:

1. A set of 3D range scans of the scene are acquired and co-registered to produce a dense 3D point cloud in a common reference frame (see Section 1).

2. An independent sequence of 2D images is gathered, taken from various viewpoints that do not necessarily coincide with those of the range scanner. A sparse 3D point cloud is reconstructed from these images by using a structure-from-motion (“SFM”) algorithm (see Section 3).

3. A subset of the 2D images is automatically registered with the dense 3D point cloud acquired from the range scanner (see Section 2).

4. Finally, the complete set of 2D images is automatically aligned with the dense 3D point cloud (see Section 4). This last step provides an integration of all the 2D and 3D data in the same frame of reference. It also provides the transformation that aligns the models gathered via range sensing and computed via structure from motion.

The contributions that are included in this document can be summarized as follows:

1. Similar to W. Zhao, D. Nister, and S. Hsu. supra., embodiments of the present invention compute a model from a collection of images via SFM. The present method for aligning the range and SFM models, described in Section 4, does not rely on ICP, and thus, does not suffer from the limitations of the teachings in Zhao et al.

2. Embodiments of the present invention can automatically compute the scale difference between the range and SFM models.

3. Similar to L. Liu and I. Stamos. supra., embodiments of the present invention perform 2D-to-3D image-to-range registration for a few (at least one) images of our collection. This feature-based method provides excellent results in the presence of a sufficient number of linear features. Therefore, the images that contain enough linear features are registered using that method. The utilization of the SFM model allows for alignment of the remaining images with a method that involves robust point (and not line) correspondences.

4. Embodiments of the present invention generate an optimal texture mapping result by using contributions of all 2D images.

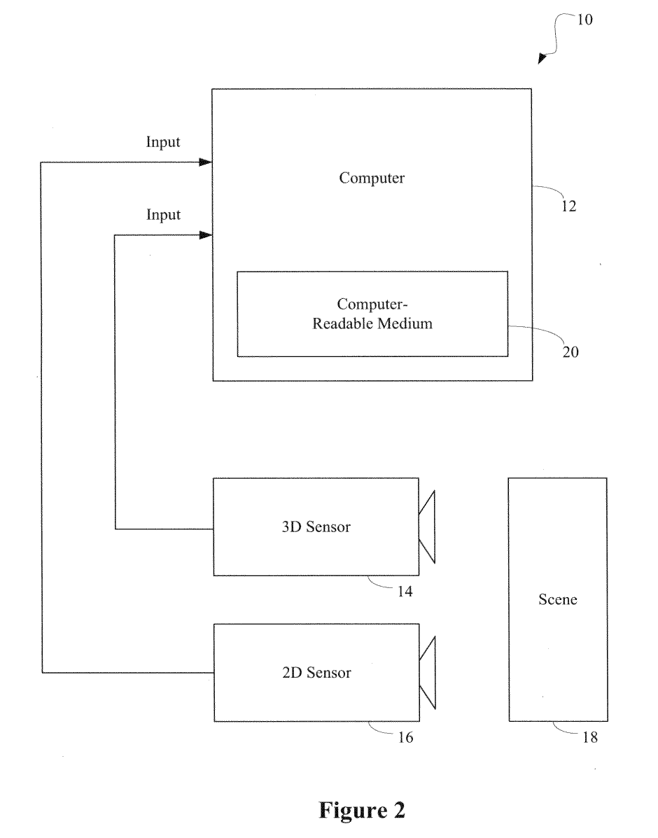

FIG. 2 shows a system 10 according to an embodiment of the present invention that is configured to implement the methods that are discussed in this document. The system includes a computer 12 that is coupled to a 3D sensor 14, e.g., a laser range scanner, which is known as light detection and ranging (“LIDAR”) or laser detection and ranging (“LADAR”), a scanning system based on the use of structured light that acquires 3D information by projecting a pattern of visible or laser light, or any other active sensor; and a 2D sensor 16, e.g., a camera or camcorder. The 3D sensor is configured to generate a plurality of 3D range scans of a scene 18, and the 2D sensor is configured to generate a plurality of 2D images, e.g., photographs or video frames, of the scene. The plurality of 3D range scans and the plurality of 2D images are output from the 3D sensor and the 2D sensor, respectively, and input to the computer. The computer includes a computer-readable medium 20, e.g., a random access memory (“RAM”), a read-only memory (“ROM”), an erasable programmable read-only memory (“EPROM” or “EEPROM”), a Flash memory, a portable compact disc read-only memory (“CDROM”), a digital video disc (“DVD”), a magnetic cassette, a magnetic tape, a magnetic disc drive, a rewritable optical disc, or any other medium that can be used to store information, which stores a computer program that is configured to implement the methods and algorithms that are discussed in this document.

### Section 1. 3D-to-3D Range Registration

The first step is to acquire a set of range scans Rₘ (m=1, . . . , M) that adequately covers the 3D scene 18. The laser range scanner 14 used in our work is a Leica HDS 2500 (see Leica Geosystems of St. Gallen, Switzerland, http://hds.leica-geosystems.com/), an active sensor that sweeps an eye-safe laser beam across the scene. It is capable of gathering one million 3D points at a maximum distance of 100 m with an accuracy of 5 mm. Each 3D point is associated with four values (x, y, z, l)^{T}, where (x, y, z)^{T} is its Cartesian coordinates in the scanner's local coordinate system, and l is the laser intensity of the returned laser beam.

Each range scan then passes through an automated segmentation algorithm (see I. Stamos and P. K. Allen. Geometry and texture recovery of scenes of large scale. Comput. Vis. Image Underst., 88(2): 94-118, 2002, which is incorporated by reference herein) to extract a set of major 3D planes and a set of geometric 3D lines Gᵢ from each scan i=1, . . . , M. The geometric 3D lines are computed as the intersections of segmented planar regions and as the borders of the segmented planar regions. In addition to the geometric lines Gᵢ, a set of reflectance 3D lines Lᵢ are extracted from each 3D range scan. The range scans are registered in the same coordinate system via the automated 3D-to-3D feature-based range-scan registration method of discussed in C. Chen and I. Stamos. Semi-automatic range to range registration: A feature-based method. In The 5th International Conference on 3-D Digital Imaging and Modeling, pages 254-261, Ottawa, June 2005, and I. Stamos and M. Leordeanu. Automated feature-based range registration of urban scenes of large scale. CVPR, 2 :555-561, 2003, which are incorporated by reference herein. The method is based on an automated matching procedure of linear features of overlapping scans. As a result, all range scans are registered with respect to one selected pivot scan. The set of registered 3D points from the M scans is called M_{range} (see FIG. 1A).

### Section 2. 2D-to-3D Image-to-Range Registration

The automated 2D-to-3D image-to-range registration method of L. Liu and I. Stamos. supra., which is incorporated by reference herein, is used for the automated calibration and registration of a single 2D image Iₙ with the 3D range model M_{range}. The computation of the rotational transformation between Iₙ and M_{range} is achieved by matching at least two vanishing points computed from Iₙ with major scene directions computed from clustering the linear features extracted from M_{range}. The method is based on the assumption that the 3D scene contains a cluster of vertical and horizontal lines. This is a valid assumption in urban scene settings.

The internal camera parameters consist of focal length, principal point, and other parameters in the camera calibration matrix K (see R. Hartley and A. Zisserman. Multiple View Geometry in Computer Vision, second edition. Cambridge University Press, 2003, which is incorporated by reference herein). They are derived from the scene's vanishing points, whereby the 2D images are assumed to be free of distortion. Finally, the translation between Iₙ and M_{range} is computed after higher-order features such as 2D rectangles from the 2D image and 3D parallelepipeds from the 3D model are extracted and automatically matched.

With this method, a few 2D images can be independently registered with the model M_{range}. The algorithm will fail to produce satisfactory results in parts of the scene 18 where there is a lack of 2D and 3D features for matching. Also, since each 2D image is independently registered with the 3D model, valuable information that can be extracted from relationships between the 2D images (“SFM”) is not utilized. In order to solve the aforementioned problems, an SFM module (see Section 3) and final alignment module (see Section 4) has been added into the system 10. These two modules increase the robustness of the reconstructed model, and improve the accuracy of the final texture mapping results. Therefore, the 2D-to-3D image-to-range registration algorithm is used in order to register a few 2D images (five shown in FIG. 1A) that produce results of high quality. The final registration of the 2D image sequence with the range model M_{range} is performed after SFM is utilized (see Section 3).

### Section 3. Multiview Pose Estimation and 3D Structure Reconstruction

The input to our system 10 is a sequence I={Iₙ|n=1, . . . , N} of high resolution still images that capture the 3D scene. This is necessary to produce photorealistic scene representations. Therefore we have to attack the problem of finding correspondences in a sequence of wide-baseline, high-resolution images, a problem that is much harder than feature tracking from a video sequence. Fortunately, there are several recent approaches that attack the wide-baseline matching problem (see F. Schaffalitzky and A. Zisserman. Viewpoint invariant texture matching and wide baseline stereo. Proc. ICCV, pages 636-643, July 2001, T. Tuytelaars and L. J. V. Gool. Matching widely separated views based on affine invariant regions. International Journal of Computer Vision, 59(1): 61-85, 2004, and D. Lowe. Distinctive image features from scale-invariant keypoints. Intl. Journal of Computer Vision, 60(2), 2004, which are incorporated by reference herein). For the purposes of the present invention's system, a scale-invariant feature transform (“SIFT”) method (see D. Lowe. supra.) is adopted for pairwise feature extraction and matching. In general, structure from motion (“SFM”) from a set of images has been rigorously studied (see 0. Faugeras, Q. T. Luong, and T. Papadopoulos. The Geometry of Multiple Images. MIT Press, 2001, R. Hartley and A. Zisserman. supra., and Y. Ma, S. Soatto, J. Kosecka, and S. Sastry. An Invitation to 3-D Vision: From Images to Geometric Models. Springer-Verlag, 2003, which are incorporated by reference herein).

A method according to the present invention for pose estimation and partial structure recovery is based on sequential updating (see P. A. Beardsley, A. P. Zisserman, and D. W. Murray. Sequential updating of projective and affine structure from motion. International Journal of Computer Vision, 23(3): 235-259, 1997, and M. Pollefeys, L. V. Gool, M. Vergauwen, F. Verbiest, K. Cornelis, J. Tops, and R. Koch. Visual modeling with a handheld camera. International Journal of Computer Vision, 59(3): 207-232, 2004, which are incorporated by reference herein). In order to get very accurate pose estimation, it is assumed that the camera(s) 16 are precalibrated. It is, of course, possible to recover unknown and varying focal length by first recovering pose and structure up to an unknown projective transform and then upgrading to Euclidean space as shown in A. Heyden and K. Astrom. Euclidean reconstruction from constant intrinsic parameters. in Proc. ICPR'92, pages 339-343, 1996, B. Triggs. Factorization methods for projective structure and motion. IEEE CVPR96, pages 845-851, 1996, and M. Pollefeys and L. V. Gool. A stratified approach to metric self-calibration. in Proc. CVPR'97, pages 407-412, 1997, which are incorporated by reference herein. However, some of the assumptions that these methods make (e.g., no skew, approximate knowledge of the aspect ratio and principal point) may produce visible mismatches in a high resolution texture map. Thus, for the sake of accuracy the present invention utilizes the camera calibration method of Z. Zhang. A flexible new technique for camera calibration. IEEE Trans. Pattern Analy. Mach. Intell., 22(11): 1330-1334, 2000, which is incorporated by reference herein.

The following steps describe the SFM implementation according to the present invention. First, the lens distortion is determined and compensated for in images Iᵢ for i=1, . . . , N. Then, for each pair of images indexed by i and i+1, a list of 2D feature matches is generated using SIFT (see D. Lowe. supra.). An initial motion and structure is computed from the first two images I₁ and I₂ as follows. The relative pose (rotation R, and translation T) is calculated by the decomposition of the essential matrix E=K^{T}FK, after the fundamental matrix F computation (via RANSAC to eliminate outliers). The matrix K contains the internal camera calibration parameters. The pose of the first camera (I₁) is set to R₁=I, T₁=0, and for the second (I₂) to R₂=R, T₂=T. Then, an initial point cloud of 3D points Xⱼ is computed from the 2D correspondences between I₁ and I₂ through triangulation. Finally, the relative pose and 3D structure is refined via the minimization of the following meaningful geometric reprojection error:

$${min}_{Ri , Ti , Xj} {\sum }_{i = 1}^{2} {\sum }_{j} {‖ {m}_{ij} - K [ {R}_{i} \vert {T}_{i} ] {X}_{j} ‖}^{2}$$

where (m₁ⱼ, m₂ⱼ) is the pair of matching 2D features between images I₁ and I₂ that produced the point Xⱼ.

After the initial motion and structure is computed from first pair, the remaining pairs are used to further augment the SFM computation. For each image Iᵢ, i=3, . . . , N the following operations are performed:

1. A set of common features are found between the three images Iᵢ₋₂, Iᵢ₋₁, and Iᵢ. These are features that have been tracked from frame Iᵢ₋₂ to frame Iᵢ₋₁ and then to frame Iᵢ via the SIFT algorithm. The 3D points associated with the matched features between Iᵢ₋₂ and Iᵢ₋₁ are recorded as well.

2. From the 2D features and 3D points collected in the previous step, the pose (Rᵢ, Ti) of image Iᵢ is computed using the Direct Linear Transform (“DLT”) with RANSAC for outlier detection. Finally, the pose is further refined via a nonlinear steepest-descent algorithm.

3. A new set of 3D points X′ⱼ can now be computed from the remaining 2D features that are seen only in images Iᵢ₋₁ and Iᵢ (these features where not seen in image Iᵢ₋₂ and thus no 3D point was computed for them). These new 3D points are projected onto the previous images of the sequence Iᵢ₋₂, . . . , and I₁ in order to reinforce more correspondences (normalized correlation with subpixel accuracy) between sub-sequences of the images in the list.

4. Finally, these new (corresponding) features and 3D points X′ⱼ are added to the database of feature correspondences/3D points. Tests that detect duplicate features and occlusions occur before their addition to the database.

The final step is the refinement of the computed pose and structure by a global bundle adjustment procedure that involves all images of the sequence. In order to do that 2D feature points that are either fully or partially tracked throughout the sequence are used. This procedure minimizes the following reprojection error:

$${min}_{Ri , Ti , Xj} {\sum }_{i = 1}^{N} {\sum }_{j} {‖ {m}_{ij} - K [ {R}_{i} \vert {T}_{i} ] {X}_{j} ‖}^{2}$$

In the previous formula each sequence of tracked 2D feature points (m₁ⱼ, m₂ⱼ, . . . , mₙⱼ) corresponds to the reconstructed 3D point Xⱼ.

### Section 4. Alignment of 2D Image Sequences Onto 3-D Range Point Clouds

The set of dense range scans {Rₘ|m=1, . . . , M} are registered in the same reference frame (see Section 1), producing a 3D range model called M_{range}. On the other hand, the sequence of 2D images I={Iₙ|n=1, . . . , produces a sparser 3D model of the scene (see Section 3) called M_{sfm}. Both of these models are represented as clouds of 3D points. The distance between any two points in M_{range} corresponds to the actual distance of the points in 3D space, whereas the distance of any two points in M_{sfm} is the actual distance multiplied by an unknown scale factor s. In order to align the two models a similarity transformation that includes the scale factor s, a rotation R and a translation T needs to be computed. In this section, a novel algorithm that automatically computes this transformation is presented. The transformation allows for the optimal texture mapping of all images onto the dense M_{range} model, and thus provides photorealistic results of high quality.

Every point X from M_{sfm} can be projected onto a 2D image Iₙ ε I by the following transformation:

x=Kₙ[Rₙ|Tₙ]X (Equation 1)

where x=(x, y, 1) is a pixel on image Iₙ, X=(X, Y, Z, 1) is a point of M_{sfm}, Kₙ is the projection matrix, Rₙ is the rotation transformation, and Tₙ is the translation vector. These matrices and points X are computed by the SFM method (see Section 3).

Some of the 2D images I′ ⊂ I are also automatically registered with the 3D range model M_{range} (see Section 2). Thus, each point of M_{range} can be projected onto each 2D image Iₙ ε I′ by the following transformation:

y=Kₙ[R′ₙ|T′ₙ]Y (Equation 2)

where y=(x, y, 1) is a pixel in image Iₙ, Y=(X, Y, Z, 1) is a point of model M_{range}, Kₙ is the projection matrix of Iₙ, R′ₙ, is the rotation, and T′ₙ is the translation. These transformations are computed by the 2D-to-3D registration method (see Section 2).

The key idea is to use the images in Iₙ ε I′ as references in order to find the corresponding points between M_{range} and M_{sfm}. The similarity transformation between M_{range} and Mₛⱼₘ is then computed based on these correspondences. In summary, the algorithm works as follows:

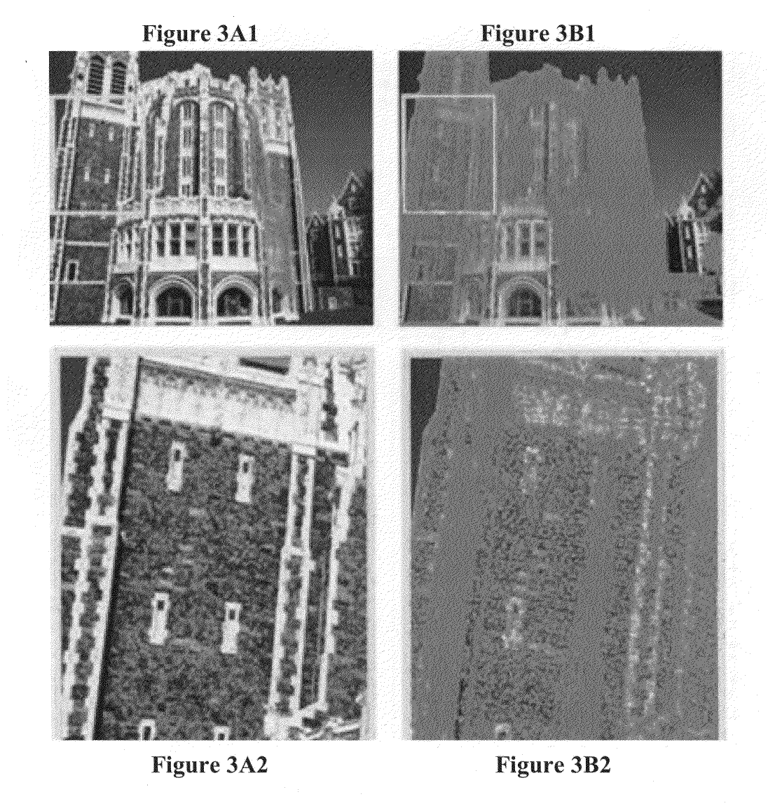

1. Each point of M_{sfm} is projected onto Iₙ ε I′ using Equation 1. Each pixel p₍ᵢⱼ₎ of Iₙ is associated with the closest projected point X ε M_{sfm} in an L×L neighborhood on the image. Each point of M_{range} is also projected onto Iₙ using Equation 2. Similarly, each pixel p₍ᵢⱼ₎ is associated with the projected point Y ε M_{range} in an L×L neighborhood (see FIGS. 3A1-3B2). Z-buffering is used to handle occlusions.

2. If a pixel p₍ᵢⱼ₎ of image Iₙ is associated with a pair of 3D points (X, Y), one from M_{sfm} and the other from M_{range}, then these two 3D points are considered as candidate matches. Thus, for each 2D-image in I′, a set of matches is computed, producing a collection of candidate matches named L. These 3D-3D correspondences between points of M_{range} and points of M_{sfm} could be potentially used for the computation of the similarity transformation between the two models. The set L contains many outliers, due to the very simple closest-point algorithm utilized. However, L can be further refined (see Section 5) into a set of robust 3D point correspondences C ⊂ L.

3. Finally, the transformation between M_{range} and M_{sfm} is computed by minimizing a weighted error function E (see Section 5) based on the final robust set of correspondences C.

### Section 5. Correspondence Refinement and Optimization

The set of candidate matches L computed in the second step of the previous algorithm contains outliers due to errors introduced from the various modules of the system (SFM, 2D-to-3D registration, range sensing). It is thus important to filter out as many outliers as possible through verification procedures. A natural verification procedure involves the difference in scale between the two models. Consider two pairs of plausible matched 3D-points (X₁, Y₁) and (X₂, Y₂) (Xᵢ denotes points from the M_{sfm} model, while Yⱼ points from the M_{range} model). If these were indeed correct correspondences, then the scale factor between the two models would be s=∥X₁−X₂∥/∥Y₁−Y₂∥. Since the computed scale factor should be the same no matter which correct matching pair is used, then a robust set of correspondences from L should contain only these pairs that produce the same scale factor s. The constant scale factor among correctly picked pairs is thus an invariant feature that we exploit. We now explain how we achieve this robust set of correspondences.

For each image Iₙ ε I′, let us call the camera's center of projection as C^{sfm}ₙ in the local coordinate system of M_{sfm} and C^{rng}ₙ in the coordinate system of M_{range}. These two centers have been computed from two independent processes: SFM (see Section 3) and 2D-to-3D registration (see Section 2). Then for any candidate match, (X, Y) ε L, a candidate scale factor s₁(X, Y) can be computed as:

s₁(X, Y)=∥X−C^{sfm}ₙ∥/∥Y−C^{rng}ₙ∥

If we keep the match (X, Y) fixed and we consider every other match (X′, Y′) ε L, L-1 candidate scale factors s₂(X′, Y′) and L-1 candidate scale factors s₃(X′, Y′) (L is the number of matches in L) are computed as:

s₂(X′, Y′)=∥X′−C^{sfm}ₙ∥/∥Y′−C^{rng}ₙ∥, s₃(X′, Y′)=∥X−X′∥/∥Y−Y′∥

That means that if the match (X, Y) fixed is kept fixed, and all other matches (X′, Y′) are considered, a triple of candidate scale factors: s₁(X, Y), s₂(X′, Y′), and s₃(X′, Y′) can be computed. Then, the two pairs of matches (X, Y) and (X′, Y′) are considered as compatible if the scale factors in the above triple are close with respect to each other. By fixing (X, Y), all matches that are compatible with it are found. The confidence in the match (X, Y) is the number of compatible matches it has. By going through all matches in L, their confidence is computed via the above procedure. Out of these matches the one with the highest confidence is selected as the most prominent: (X_{P}, Y_{P}). Let us call Lₙ the set that contains (X_{P}, Y_{P}) and all other matches that are compatible with it. Note that this set is based on the centers of projection of image Iₙ as computed by SFM and 2D-to-3D registration. Let us also call sₙ the scale factor that corresponds to the set Lₙ. This scale factor can be computed by averaging the triples of scale factors of the elements in Lₙ. Finally, a different set Lₙ and scale factor sₙ is computed for every image Iₙ ε I′.

From the previous discussion it is clear that each Lₙ is a set of matches that is based on the center of projection of each image Iₙ independently. A set of matches that will provide a globally optimal solution should consider all images of I′ simultaneously. Out of the scale factors computed from each set Lₙ, the one that corresponds to the largest number of matches is the one more robustly extracted by the above procedure. That computed scale factor, sₒₚₜ, is used as the final filtration for the production of the robust set of matches C out of L. In particular, for each candidate match (X, Y) ε L, a set of scale factors are computed as

s′₂=∥X−C^{sfm}ₙ∥/∥Y−C^{rng}ₙ∥

where n=1, 2, . . . , K, and K is the number of images in I′. The standard deviation of those scale factors with respect to sₒₚₜ is computed, and if it is smaller than a user-defined threshold, (X, Y) is considered as a robust match and is added to the final list of correspondences C. The robustness of the match stems from the fact that it verifies the robustly extracted scale factor sₒₚₜ with respect to most (or all) images Iₙ ε I′. The pairs of center of projections (C^{sfm}ₙ, C^{rng}ₙ) of images in I′ are also added to C.

The list C contains robust 3D point correspondences that are used for the accurate computation of the similarity transformation (scale factor s, rotation R, and translation T) between the models M_{range} and M_{sfm}. The following weighted error function is minimized with respect to sR and T:

$$E = {\sum }_{( X , Y ) ∈ C} w {‖ sR \cdot Y + T - X ‖}^{2}$$

where the weight w=1 for all (X, Y) ε C that are not the centers of projection of the cameras, and w>1 (user defined) when (X, Y)=(C^{sfm}ₙ, C^{rng}ₙ). By associating higher weights to the centers we exploit the fact that we are confident in the original pose produced by SFM and 2D to-3D registration. The unknown sR and T are estimated by computing the least square solution from this error function. Note that s can be easily extracted from sR since the determinant of R is 1.

In summary, by utilizing the invariance of the scale factor between corresponding points in M_{range} and M_{sfm}, a set of robust 3D point correspondences is computed. These 3D point correspondences C are then used for an optimal calculation of the similarity transformation between the two point clouds. This provides a very accurate texture mapping result of the high resolution images onto the dense range model M_{range}.

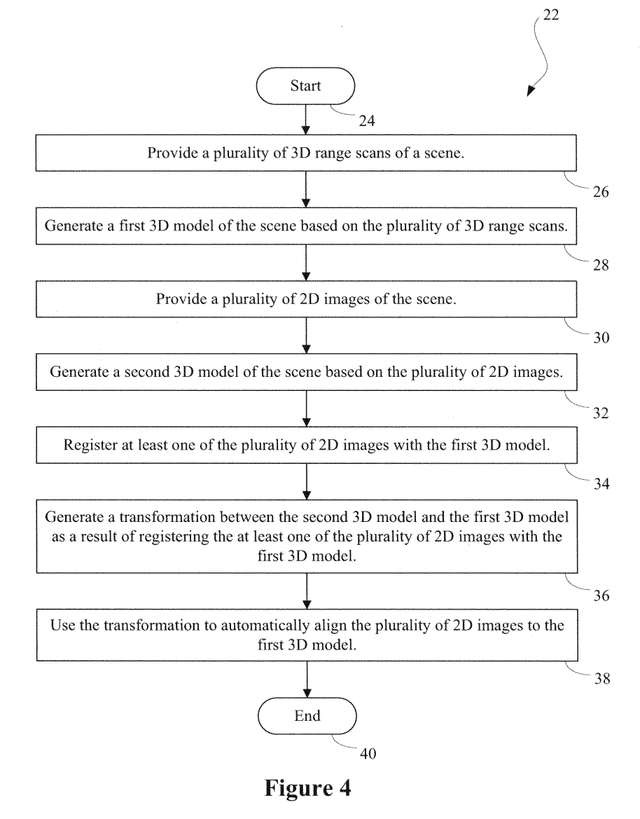

FIG. 4 is a flowchart of an example algorithm 22 according to the present invention for texture mapping a plurality of 2D images of a scene 18 to a 3D model of the scene. After starting a step 24, the next step 26 of the algorithm is to provide a plurality of 3D range scans of the scene. Next, at step 28, a first 3D model of the scene is generated based on the plurality of 3D range scans. At step 30, a plurality of 2D images of the scene is provided. Next, at step 32, a second 3D model of the scene is generated based on the plurality of 2D images.

The next step 34 of the algorithm 22 is to register at least one of the plurality of 2D images with the first 3D model. Next, at step 36, a transformation between the second 3D model and the first 3D model is generated as a result of registering the at least one of the plurality of 2D images with the first 3D model. At step 38, the transformation is used to automatically align the plurality of 2D images to the first 3D model. The algorithm ends at step 40.

### Section 6. Results

Tests were performed of the algorithms according to the present invention using range scans and 2D images acquired from a large-scale urban structure (Shepard Hall/CCNY) and from an interior scene (Great Hall/CCNY). 22 range scans of the exterior of Shepard Hall were automatically registered (see FIG. 1) to produce a dense model M_{range}. In one experiment, ten images where gathered under the same lighting conditions. All ten of them were independently registered (2D-to-3D registration of Section 2) with the model M_{range}. The registration was optimized with the incorporation of the SFM model (see Section 3) and the final optimization method (see Sections 4 and 5).

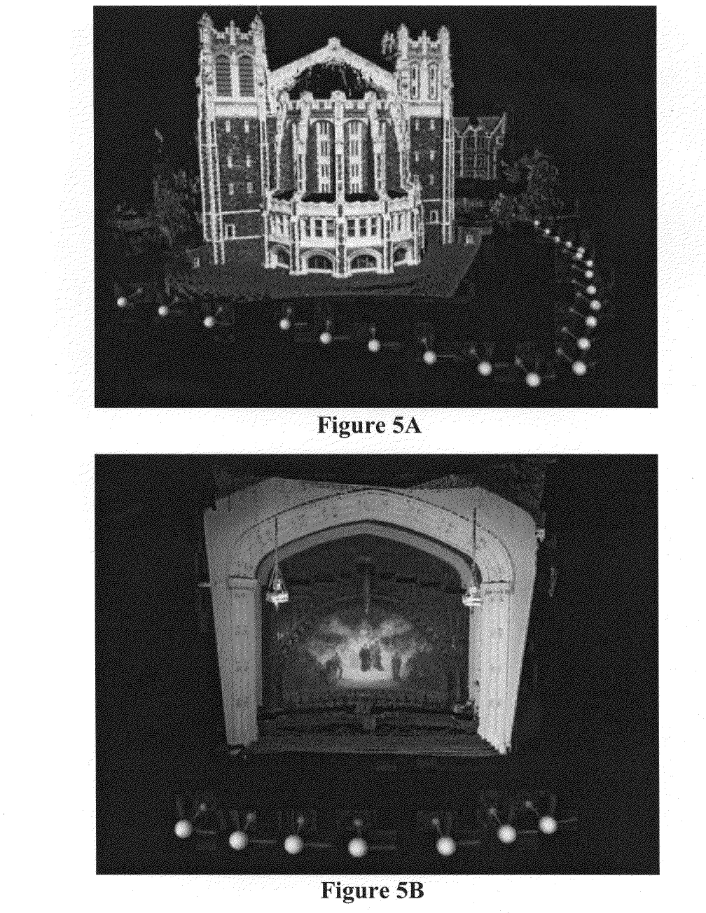

In a second experiment, 22 images of Shepard Hall that covered a wider area were acquired. Although the automated 2D-to-3D registration method was applied to all the images, only five of them were manually selected for the final transformation (see Section 4) on the basis of visual accuracy. For some of the 22 images the automated 2D-to-3D method could not be applied due to lack of linear features. However, all 22 images were optimally registered using the novel registration method of the present invention (see Section 4) after the SFM computation (see Section 3). FIG. 1 shows the alignment of the range and SFM models achieved through the use of the 2D images. In FIG. 5A, the accuracy of the texture mapping method is visible. FIG. 5B displays a similar result of an interior 3D scene. Table 1 (see below) provides some quantitative results of the experiments. Notice the density of the range models versus the sparsity of the SFM models. Also notice the number of robust matches in C (see Section 4) with respect to the possible number of matches (i.e., number of points in SFM). The final row of Table 1 displays the elapsed time for the final optimization on a Dell PC running Linux on an Intel Xeon-2 GHz, 2 GB-RAM machine.

TABLE 1
Quantitative results.

| | Shepard Hall | Great Hall |
|---|---|---|
| Number of points (M_{range}) | 12,483,568 | 13,234,532 |

| | | | |
|---|---|---|---|
| Number of points (M_{sfm}) | 2,034 | 45,392 | 1,655 |
| 2D-images used | 10 | 22 | 7 |
| 2D-to-3D registrations | 10 | 5 | 3 |
| (see Section 2) | | | |
| Number of matches in C | 258 | 1632 | 156 |
| (see Section 4) | | | |
| Final optimization | 8.65 s | 19.20 s | 3.18 s |
| (see Section 4) | | | |

Advantageously, a system and related methods have been presented that integrate multiview geometry and automated 3D registration techniques for texture mapping high resolution 2D images onto dense 3D range data. According to the present invention multiview geometry (“SFM”) and automated 2D-to-3D registration are merged for the production of photorealistic models with minimal human interaction. The present invention provides increased robustness, efficiency, and generality with respect to previous methods.

All features disclosed in the specification, including the abstract, drawings, and all of the steps in any method or process disclosed, may be combined in any combination, except combinations where at least some of such features and/or steps are mutually exclusive. Each feature disclosed in the specification, abstract, and drawings, can be replaced by alternative features serving the same, equivalent, or similar purposes, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention.

We claim:

1. A method for automatically aligning a plurality of 2D images of a scene to a first 3D model of the scene, the method comprising:
a. providing a plurality of 2D images of the scene;
b. generating a second 3D model of the scene based on the plurality of 2D images;
c. generating a transformation between the second 3D model and the first 3D model based on a comparison of at least one of the plurality of 2D images to the first 3D model; and
d. using the transformation to automatically align the plurality of 2D images to the first 3D model.

2. The method according to claim 1, wherein the step of generating a second 3D model based on the plurality of 2D images includes generating a sparse 3D point cloud from the plurality of 2D images using a multiview geometry algorithm.

3. The method according to claim 1, where the first 3D model is generated from a range scan.

4. The method according to claim 1, where the first 3D model is received from a 3D computer modeling software tool.

5. The method according to claim 2, wherein:
a. the scene includes an object;
b. the object includes a plurality of features;
c. each of the plurality of features has one of a plurality of 3D positions;
d. the plurality of 2D images were created using a 2D sensor;
e. the 2D sensor was at one of a plurality of sensor positions relative to the image when each of the plurality of 2D images was created; and
f. the multiview geometry algorithm is used to determine at least one of the plurality of sensor positions and at least one of the plurality of 3D positions.

6. The method according to claim 2, wherein:
a. the plurality of 2D images are mathematically represented as a sequence of N images, I={I₁, I₂, . . . , I_{N}}, wherein the i^{th} image in the sequence is denoted Iᵢ;
b. the plurality of 2D images include 2D features;
b. the 2D images were generated using a 2D sensor having a lens;
c. the lens is characterized as having a lens distortion; and
d. the multiview geometry algorithm includes the following steps:
i. determining the lens distortion,
ii. compensating for the lens distortion in the sequence of N images representing the plurality of 2D images, {I₁, I₂, . . . , I_{N}},
iii. for each pair of successive 2D images, Iᵢ and Iᵢ₊₁, generating a list of 2D features matches using a feature-based matching process,
iv. computing an initial motion and an initial structure from first two 2D images in the sequence, I₁ and I₂, and
v. computing a motion and a structure for pairs of successive 2D images, Iᵢ₋₁ and Iᵢ, for each value i in the range from 3 to N.

7. The method according to claim 6, wherein the initial motion and the initial structure from 2D images I₁ and I₂ are computed as follows:
a. calculating a relative pose of the 2D sensor that includes a rotation transformation R and a translation vector T by decomposing an essential matrix E=K^{T}FK, wherein the matrix K includes internal calibration parameters for the 2D sensor and F is a fundamental matrix;
b. setting a pose of the 2D sensor for the first 2D image I₁ where R₁ is an identity matrix, and T₁ is an all-zero vector;
c. setting a pose of the 2D sensor for the second 2D image I₂ so R₂=R, and T₂=T;
d. computing an initial point cloud of 3D points Xⱼ from 2D correspondences between I₁ and I₂ though triangulation; and
e. refining the relative pose of the 2D sensor by minimizing a geometric reprojection error.

8. The method according to claim 6, wherein the multiview geometry algorithm further includes the following steps to process image Iᵢ for each value i in the range from 3 to N:
a. determining a set of common features between the three images Iᵢ₋₂, Iᵢ₋₁, and Iᵢ, where the common features are the features that have been tracked from frame Iᵢ₋₂ to frame Iᵢ₋₁ and then to frame Iᵢ via the feature-based matching process;
b. recording 3D points that are associated with the matched features between Iᵢ₋₂ and Iᵢ₋₁;
c. computing the pose (Rᵢ, Tᵢ) of the image Iᵢ from the 2D features and the 3D points using a Direct Linear Transform (“DLT”) with a Random Sample Consensus (“RANSAC”) for outlier detection;
d. refining the pose using a nonlinear steepest-descent algorithm,
e. computing from the remaining 2D features that are seen in images Iᵢ₋₁ and Iᵢ and not seen in image Iᵢ₋₂ a new set of 3D points X′ⱼ;
f. projecting the new set of 3D points onto the previous images of the sequence Iᵢ₋₂, . . . , Iᵢ in order to reinforce more correspondence between sub-sequences of the images in the list; and
g. adding new corresponding features and 3D points X′ⱼ to the database of feature correspondences and 3D points.

9. The method according to claim 8, wherein the multiview geometry algorithm further includes performing a global bundle adjustment procedure that involves all of the 2D images from the sequence by minimizing a reprojection error.

10. The method according to claim 1, wherein:
a. each of the plurality of 2D images was collected from one of a plurality of viewpoints; and
b. no advance knowledge of the plurality of viewpoints is required before performing the method according to claim 1 if at least one of the plurality of 2D images overlaps the 3D model.

11. The method according to claim 1, wherein the step of generating the transformation between the second 3D model and the first 3D model comprises the steps of:
forming hypotheses by randomly selecting matches among the first 3D model and second 3D model;
testing these hypotheses on all of the matches between the first 3D model and second 3D model; and
selecting a scale factor that is most consistent with the complete dataset.

12. A method for texture mapping a plurality of 2D images of a scene to a 3D model of the scene, the method comprising:
a. providing a plurality of 3D range scans of the scene;
b. generating a first 3D model of the scene based on the plurality of 3D range scans;
c. providing a plurality of 2D images of the scene;
d. generating a second 3D model of the scene based on the plurality of 2D images;
e. registering at least one of the plurality of 2D images with the first 3D model;
f. generating a transformation between the second 3D model and the first 3D model as a result of registering the at least one of the plurality of 2D images with the first 3D model; and
g. using the transformation to automatically align the plurality of 2D images to the first 3D model.

13. The method according to claim 12, wherein:
a. the plurality of 3D range scans include lines; and
b. the step of generating the first 3D model based on the plurality of 3D range scans includes generating a dense 3D point cloud using a 3D-to-3D registration method that:
i. matches the lines in the plurality of 3D range scans, and
ii. brings the plurality of 3D range scans into a common reference frame.

14. The method according to claim 12, wherein the step of generating the second 3D model based on the plurality of 2D images includes generating a sparse 3D point cloud from the plurality of 2D images using a multiview geometry algorithm.

15. The method according to claim 14, wherein:
a. the scene includes an object;
b. the object includes a plurality of features;
c. each of the plurality of features has one of a plurality of 3D positions;
d. the plurality of 2D images were created using a 2D sensor;
e. the 2D sensor was at one of a plurality of sensor positions relative to the image when each of the plurality of 2D images was created; and
f. the multiview geometry algorithm is used to determine at least one of the plurality of sensor positions and at least one of the plurality of 3D positions.

16. The method according to claim 12, wherein:
a. the plurality of 3D range scans are collected from a first plurality of viewpoints;
b. the plurality of 2D images are collected from a second plurality of viewpoints; and
c. not all of the second plurality of viewpoints coincide with the first plurality of viewpoints.

17. The method according to claim 12, wherein:
a. each of the plurality of 2D images is collected from one of a plurality of viewpoints; and
b. no advance knowledge of the plurality of viewpoints is required before performing the method if at least one of the plurality of 2D images overlaps the 3D model.

18. The method according to claim 12, wherein the step of generating the transformation between the second 3D model and the first 3D model comprises the steps of:
forming hypotheses by randomly selecting matches among the first 3D model and second 3D model;
testing these hypotheses on all of the matches between the first 3D model and second 3D model; and
selecting a scale factor that is most consistent with the complete dataset.

19. A system comprising:
a 3D sensor configured to generate a plurality of 3D range scans of a scene;
a 2D sensor configured to generate a plurality of 2D images of the scene; and
a computer that is coupled to the 3D sensor and the 2D sensor, and includes a computer-readable medium having a computer program that, when executed by the computer, texture maps the plurality of 2D images of the scene onto a first 3D model of the scene, wherein the computer is operable to do the following steps:
i. receive as input the plurality of 3D range scans and the plurality of 2D images,
ii. generate the first 3D model of the scene based on the plurality of 3D range scans,
iii. generate a second 3D model of the scene based on the plurality of 2D images,
iv. register at least one of the plurality of 2D images with the first 3D model,
v. generate a transformation between the second 3D model and the first 3D model as a result of the registering of the at least one of the plurality of 2D images with the first 3D model, and
vi. use the transformation to automatically align the plurality of 2D images to the first 3D model.

20. The system according to claim 19, wherein:
a. the 3D sensor is configured to generate the plurality of 3D range scans of the scene from a first plurality of viewpoints;
b. the 2D sensor is configured to generate the plurality of 2D images of the scene from a second plurality of viewpoints; and
c. not all of the second plurality of viewpoints coincide with the first plurality of viewpoints.
